(19) United States
(12) Patent Application Publication
(10) Pub. No.: US 2026/0093455 A1
(43) Pub. Date: Apr. 2, 2026

(54) DEVICE AND METHOD FOR CONFIGURING A RANDOM NUMBER GENERATOR AND METHOD FOR GENERATING RANDOM NUMBERS

(71) Applicant: Infineon Technologies AG, Neubiberg (DE)

(72) Inventors: Lars Tebelmann, Muenchen (DE); Berndt Gammel, Markt-Schwaben (DE); Rainer Göttfert, Putzbrunn (DE)

(21) Appl. No.: 19/336,982

(22) Filed: Sep. 23, 2025

(30) Foreign Application Priority Data
Sep. 23, 2024 (DE) 102024209104.9

(51) Int. Cl. G06F 7/58

(52) U.S. Cl. CPC G06F 7/582

(57) ABSTRACT

Data processing device having a defining apparatus to define multi-bit output symbols of a random symbol source used to generate a single random number, a determination apparatus configured to use predetermined transition probabilities between output symbols of the random symbol source to determine, for every possible sequence of the specified number of multi-bit output symbols, a probability that the random symbol source outputs that sequence, a grouping apparatus to group the possible sequences into groups such that the overall probabilities of the groups are as equal as possible, wherein each group's overall probability is the sum of the determined probabilities of the sequences belonging to that group, and an assignment apparatus to assign a random number to each group as the random number to be output by the random number generator for the sequences of random symbols belonging to that group.

### TECHNICAL FIELD

Exemplary aspects generally relate to devices and methods for configuring a random number generator and methods for generating random numbers.

### BACKGROUND

Random numbers are used in data processing devices for various applications. Typically, it is important that the random numbers have high entropy. For this purpose, random symbols as are supplied by a random symbol source or “noise source” can be post-processed by combining a plurality of random symbols and processing them to form a random number, so that the entropy is “compressed” in this way. Approaches that are effective and efficient to implement are desirable for this.

### SUMMARY

According to one exemplary aspect, a data processing device is provided, having a defining apparatus, set up for defining a number of multi-bit output symbols of a random symbol source which should be used for generating a single random number, a determination apparatus, set up for using predetermined transition probabilities between two or more output symbols of the random symbol source to determine, for every possible sequence of the specified number of multi-bit output symbols of the random symbol source, a probability that the random symbol source outputs that sequence, a grouping apparatus, set up for grouping the possible sequences of output symbols of the random symbol source into groups according to the criterion that the overall probabilities of the groups are as equal as possible, wherein for each group the overall probability is determined as the sum of the determined probabilities of the random symbol source outputting the sequences belonging to the group, and an assignment apparatus, set up for assigning a random number to each group as a random number which is to be output by the random number generator for the sequences of the random symbols which belong to the group.

According to a further exemplary aspect, a method for configuring a random number generator is provided, comprising defining a number of multi-bit output symbols of a random symbol source which should be used for generating a single random number, using predetermined transition probabilities between two or more output symbols of the random symbol source to determine, for every possible sequence of the specified number of multi-bit output symbols of the random symbol source, a probability that the random symbol source outputs that sequence, grouping the possible sequences of output symbols of the random symbol source into groups according to the criterion that the overall probabilities of the groups are as equal as possible, wherein for each group the overall probability is determined as the sum of the determined probabilities of the random symbol source outputting the sequences belonging to the group, and assigning a random number to each group as a random number which is to be output by the random number generator for the sequences of the random symbols which belong to the group.

### BRIEF DESCRIPTION OF THE DRAWINGS

The figures do not reproduce the actual size relationships, but rather are intended to serve to illustrate the principles of the various exemplary aspects. Various exemplary aspects are described below with reference to the following figures.

FIG. 1 shows an example of a data processing device.

FIG. 2 shows a hardware implementation of a compression function according to one aspect.

FIG. 3 shows a flowchart illustrating a method for configuring a random number generator in accordance with one aspect.

### DETAILED DESCRIPTION

The following detailed description refers to the accompanying figures, which show details and exemplary aspects. These exemplary aspects are described in such detail that a person skilled in the art is able to carry out the disclosed subject matter. Other aspects are also possible and the exemplary aspects may be changed in structural, logical and electrical terms without departing from the subject matter of the disclosed subject matter. The various exemplary aspects are not necessarily mutually exclusive; rather, various aspects may be combined with one another to produce new aspects. In the context of this description, the terms “connected”, “attached” and “coupled” are used to describe both a direct and an indirect connection, a direct or indirect attachment and a direct or indirect coupling.

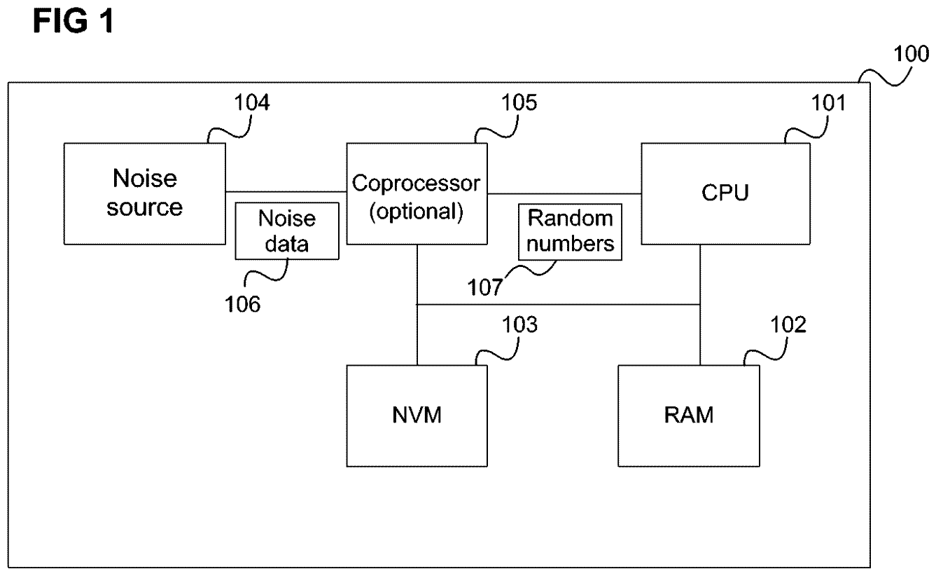

FIG. 1 shows an example of a data processing device 100 having a main processor (CPU) 101, a RAM (random access memory) 102, a non-volatile memory 103 (NVM), and a noise source (or “random (symbol) source”) 104 as the basis for generating random numbers, which are then used for example by the CPU 101, e.g. for a cryptographic algorithm or protective measures for such, e.g. for generating masks for protection against side-channel attacks.

A random number generator for “true” random numbers (TRNG, true RNG) typically consists of a physical noise source (NS) 104, which generates noise data (or raw data) 106, and subsequent mathematical post-processing, which compresses the generated raw data 106 and in this way increases the per-bit entropy of the random numbers 107 that are generated (compared to the raw data) (i.e. the post-processed random numbers contain more entropy per bit than the raw data).

Post-processing can be realized in software. In the example of FIG. 1, it is carried out by a coprocessor 105, which is for example provided in a dedicated manner for this purpose. However, it can also be carried out by the CPU 101 itself. For example, the program code for post processing 103 is stored in NVM 103 and is loaded into the main memory 102 for execution.

The data processing device 100 may be any type of data processing device having at least one programmable processor, such as for example a computer or a smartphone, a chip card (with any form factor) or a control apparatus (for example with a microcontroller) that is used in a vehicle, for example.

A random number generator is now considered, which outputs a symbol per unit time (e.g. per clock cycle of the CPU 101). The symbols are elements of a finite set M of cardinality |M|=n≥2. Usually, these output symbols are represented by integers 1, 2, . . . , n or by 0, 1, . . . , n−1. Therefore, when both the random number generator and the noise source are mentioned, the output symbols of the (random number generator to be configured or implemented) will also be referred to as output random numbers (to avoid confusion with the symbols output by the noise source 104). However, a random number (output by the random number generator) can generally be understood to be a random symbol (which in turn is typically represented as a bit sequence and thus as a (binary) number). In the following, the symbols are also sometimes shown in bold to avoid confusion with the binary numbers 0 and 1.

In the case of an ideal random number generator, the output symbols are output independently of one another and with the same probability (this then corresponds to 100% entropy). For a real random number generator, both properties are generally violated. That is to say, the individual symbols are output with different probability. In addition, the probability of a symbol occurring (as the output of the random number generator) depends on the values of the symbols previously produced by the random number generator (memory effect).

The sequence of the random variables X₁, X₂, X₃, . . . , Xₜ, Xₜ₊₁, . . . , which represents the sequence of symbols output by the random number generator, defines a stochastic process.

An important special case exists if the probability Pr(Xₜ₊₁=j) for the occurrence of the symbol j at time point t+1 is determined completely by the symbol which occurred directly before it. (Any symbols which occurred even earlier can be ignored.) This special case of a stochastic process is called the Markov process. The sequence X₁, X₂, X₃, . . . is then called the Markov chain.

Formally expressed: A stationary (i.e. time-independent) stochastic process X₁, X₂, X₃, . . . forms a Markov chain if

$$Pr ( {X}_{t + 1} = j \vert {X}_{t} = i , {X}_{t - 1} = {i}_{t - 1} , … , {X}_{2} = {i}_{2} , {X}_{1} = {i}_{1} ) = Pr ( {X}_{t + 1} = j \vert {X}_{t} = i )$$

for all possible symbols i, j; i₁, i₂, . . . iₜ₋₁∈M and for all time points t.

The probability

$${P}_{i j} = P r ( {X}_{t + 1} = j \vert {X}_{t} = i )$$

is called the transition probability from state i to state j. (It should be noted that in a process that is assumed to be stationary here (i.e. the random number generator does not change its properties over time) the time point t does not matter: The same probability Pᵢⱼ results for all values t=1, 2, . . . in the above formula.) The property of stationarity is generally fulfilled, namely when the random number generator maintains its statistical behavior over time.

A stationary Markov process (over an n-element set) is defined completely by the n×n matrix

$$P = ( {P}_{i j} )$$

of all transition probabilities Pᵢⱼ.

Example 1a: If n=4 and M={0, 1, 2, 3}. Then the matrix

$$P = ( \begin{matrix}{P}_{00} & {P}_{01} & {P}_{02} & {P}_{03} \\ {P}_{10} & {P}_{11} & {P}_{12} & {P}_{13} \\ {P}_{20} & {P}_{21} & {P}_{22} & {P}_{23} \\ {P}_{30} & {P}_{31} & {P}_{32} & {P}_{33}\end{matrix} ) = ( \begin{matrix}0 & 1 & 0 & 0 \\ \frac{1}{9} & 0 & \frac{4}{9} & \frac{4}{9} \\ \frac{1}{12} & \frac{1}{4} & \frac{1}{3} & \frac{1}{3} \\ \frac{1}{12} & \frac{1}{4} & \frac{1}{3} & \frac{1}{3}\end{matrix} ) \qquad ( 1 )$$

defines a Markov process.

The stationary distribution u of a stationary Markov process is the consequence of the probabilities with which the individual symbols appear (over time). The entropy rate R of the stationary Markov process is the average entropy content of an output symbol.

Both variables, the stationary probability distribution u and the entropy rate R, can be calculated with the aid of the matrix P of transition probabilities.

Example 1b (continuation of example 1a): The stationary probability distribution μ=(μ₀, μ₁, μ₂, μ₃) is obtained by solving the linear system of equations

$$μ P = μ$$

with the secondary condition μ₀+μ₁+μ₂+μ₃=1. For the above matrix P (from example 1a), the following results

$${μ}_{0} = \frac{1}{12} , \qquad {μ}_{1} = \frac{1}{4} , \qquad and \qquad {μ}_{2} = {μ}_{3} = \frac{1}{3} .$$

That is, the symbol 0 appears with probability 1/12. The symbol 1 appears with probability 1/4. And the symbols 2 and 3 each appear with probability 1/3.

The entropy rate R of the Markov process considered results from the formula

$$R = - {\sum }_{i = 0}^{n - 1} {μ}_{i} {\sum }_{j = 0}^{n - 1} {P}_{i j} {log}_{2} {P}_{i j} = 1.585 .$$

As n=4, that is there are four possible output symbols, the output symbols of an ideal random number generator would have the entropy 2 (per symbol). In this case, the entropy rate would likewise be equal to 2.

The following statement is used in the following.

Proposition 1: If (a, b, . . . , c, d) is an arbitrary sequence of r symbols of a stationary Markov chain X₁, X₂, . . . . Then the following applies for all t=1, 2, . . . .

$$P r ( {X}_{t} = a , {X}_{t + 1} = b , … , {X}_{t + r - 2} = c , {X}_{t + r - 1} = d ) = Pr ( {X}_{t} = a ) \cdot Pr ( {X}_{t + 1} = b \vert {X}_{t} = a ) … Pr ( {X}_{t + r - 1} = d \vert {X}_{t + r - 2} = c ) .$$

The probability Pr(Xₜ=a) can be taken from the stationary probability distribution here. The remaining probabilities can be taken from the matrix P of transition probabilities.

In the following, (entropy compressing) post-processing is described, which is used according to various aspects for a Markov-type noise source 104.

An increase in the per-symbol entropy (i.e. entropy compression) is only possible by data compression. If r is the selected (defined) compression rate. That is, from in each case r≥2 output symbols σ₁, σ₂, . . . , σᵣ∈M of the noise source, a single random number σ (which is the post-processed symbol, i.e. the output of the random number generator) is obtained by means of post processing. The r symbols σ₁, . . . , σᵣ are multi-bit symbols, i.e. consist of or correspond to several bits in each case and constitute the input of the post-processing algorithm ψ, the random number o constitutes its output. Since all symbols (σ₁, σ₂, . . . , σᵣ and σ) in this example belong to the n-element set M, ψ (in this example, the general case that o is from a different set than σ₁, σ₂, . . . , σᵣ is however also possible) is a mapping of the set M^{r} into the set M.

$$ψ : ( {σ}_{1} , … , {σ}_{r} ) ∈ {M}^{r} ↦ σ ∈ M .$$

Compression functions which are used for the purpose of entropy compression are usually balanced functions. Balanced functions have the property that for each σ∈M, just as many r-tuples (σ₁, . . . , σᵣ)∈M^{r} exist, which are mapped onto the element o by the function. In other words, each of the n possible output random numbers σ from M has exactly n^{r-1} archetypes in M^{r}.

Furthermore, compression functions usually used for entropy compression are for the most part linear. Non-singular linear feedback shift registers and binary matrices with maximum rank are e.g. frequently used linear compression functions. However, a precise analysis shows that in the case of Markov chains, with suitable unbalanced and nonlinear compression functions, more entropy can be extracted from the raw data of the noise source.

Therefore, according to various aspects, a nonlinear and unbalanced compression algorithm is used for post-processing output symbols of a Markov chain type noise source (i.e. a post-processing algorithm) as described in the following.

Post-processing algorithm:
1. Consider all n^{r} possible r-tuples (σ₁, . . . , σᵣ)∈M^{r}. For each of these r-tuples, calculate the probability that it is produced in r steps by the noise source. (For each unit time (approximately per CPU clock), the noise source outputs a symbol. In r cycles, an r-tuple is therefore generated.) The formula from proposition 1 is used for calculating the probability of occurrence for a specific r-tuple.
2. Divide the set of all r-tuples (σ₁, . . . , σᵣ)∈M^{r} into n paired disjoint classes K₀, K₁, . . . , Kₙ₋₁ (i.e. group the (possible) sequences of random symbols that can be output from the noise source). This is done in such a way (i.e. according to the criterion) that the sum of the probabilities of all r-tuples of a class comes as close as possible to the ideal value 1/n (i.e. are as equal as possible). So the n classes (or “groups”) have the following properties

$$\begin{matrix}{K}_{0} ⋃ {K}_{1} ⋃ … ⋃ {K}_{n - 1} = {M}^{r} ; \\ {K}_{i} ⋂ {K}_{j} = ∅ for 0 \leq i < j \leq n - 1 ; \\ \vert {K}_{0} \vert + \vert {K}_{1} \vert + … + \vert {K}_{n - 1} \vert = {n}^{r} .\end{matrix}$$

and for all i=0, 1, . . . n−1 the following applies

$${\sum }_{( {σ}_{1} , … , {σ}_{r} ) ∈ {K}_{i}} {μ}_{{σ}_{1}} {P}_{{σ}_{1} {σ}_{2}} {P}_{{σ}_{2} {σ}_{3}} … {P}_{{σ}_{r - 1} {σ}_{r}} \approx \frac{1}{n} .$$

3. The compression function ψ: M^{r}→M is defined as follows: Assign the number of a class to all r tuples of the class as a function value (as a random number to be output for sequences from that class). That is, set

$$ψ ( ( {σ}_{1} , … , {σ}_{r} ) ) = σ ⇔ ( {σ}_{1} , … , {σ}_{r} ) ∈ {K}_{σ} \qquad for σ = 0 , 1 , … , n - 1 .$$

Example 1c (continuation of examples 1a and 1b): M={0,1,2,3}. Compression rate r=2. It follows from proposition 1 that: The 2-tuple (a, b)∈M² occurs with probability

$$P r ( {X}_{t} = a ) \cdot Pr ( {X}_{t + 1} = b \vert {X}_{t} = a ) = {μ}_{a} {P}_{a b}$$

wherein μₐ is taken from the probability distribution μ=(μ₀, μ₁, μ₂, μ₃) calculated in example 1b and P_{ab} is taken from the matrix P provided in example 1a.

Table 1 is the list of the 16 possible pairs (a, b) with the associated probabilities of occurrence for each pair. Due to the known probabilities of occurrence, the function value ψ(a, b) of the compression function ψ was chosen so that each output random number occurs with the same probability.

TABLE 1
Definition of the compression function ψ

| a | b | μₐP_{ab} | ψ(a, b) |
|---|---|---|---|
| 0 | 0 | $\frac{1}{12} \cdot 0 = 0$ | 0 |
| 0 | 1 | $\frac{1}{12} \cdot 1 = \frac{1}{12}$ | 0 |
| 0 | 2 | $\frac{1}{12} \cdot 0 = 0$ | 0 |
| 0 | 3 | $\frac{1}{12} \cdot 0 = 0$ | 0 |
| 1 | 0 | $\frac{1}{4} \cdot \frac{1}{9} = \frac{1}{36}$ | 1 |
| 1 | 1 | $\frac{1}{4} \cdot 0 = 0$ | 0 |
| 1 | 2 | $\frac{1}{4} \cdot \frac{4}{9} = \frac{1}{9}$ | 1 |
| 1 | 3 | $\frac{1}{4} \cdot \frac{4}{9} = \frac{1}{9}$ | 1 |
| 2 | 0 | $\frac{1}{3} \cdot \frac{1}{12} = \frac{1}{36}$ | 2 |
| 2 | 1 | $\frac{1}{3} \cdot \frac{1}{4} = \frac{1}{12}$ | 0 |
| 2 | 2 | $\frac{1}{3} \cdot \frac{1}{3} = \frac{1}{9}$ | 2 |
| 2 | 3 | $\frac{1}{3} \cdot \frac{1}{3} = \frac{1}{9}$ | 2 |
| 3 | 0 | $\frac{1}{3} \cdot \frac{1}{12} = \frac{1}{36}$ | 3 |
| 3 | 1 | $\frac{1}{3} \cdot \frac{1}{4} = \frac{1}{12}$ | 0 |
| 3 | 2 | $\frac{1}{3} \cdot \frac{1}{3} = \frac{1}{9}$ | 3 |
| 3 | 3 | $\frac{1}{3} \cdot \frac{1}{3} = \frac{1}{9}$ | 3 |

It holds that

$$\begin{matrix}Pr ( ψ ( a , b ) = 0 ) = Pr ( ( a , b ) = ( 0 , 0 ) ) + P r ( ( a , b ) = ( 0 , 1 ) ) + Pr ( ( a , b ) = ( 0 , 2 ) ) + P r ( ( a , b ) = ( 0 , 3 ) ) + Pr ( ( a , b ) = ( 1 , 1 ) ) + P r ( ( a , b ) = ( 2 , 1 ) ) + Pr ( ( a , b ) = ( 3 , 1 ) ) \\ = 0 + \frac{1}{12} + 0 + 0 + 0 + \frac{1}{12} + \frac{1}{12} = \frac{1}{4} ;\end{matrix}$$

$$\begin{matrix}Pr ( ψ ( a , b ) = 1 ) = Pr ( ( a , b ) = ( 1 , 0 ) ) + P r ( ( a , b ) = ( 1 , 2 ) ) + Pr ( ( a , b ) = ( 1 , 3 ) ) \\ = \frac{1}{36} + \frac{1}{9} + \frac{1}{9} = \frac{1}{4} .\end{matrix}$$

Likewise, the following results

$$Pr ( ψ ( a , b ) = 2 ) = \frac{1}{4} \qquad and \qquad Pr ( ψ ( a , b ) = 3 ) = \frac{1}{4} .$$

The underlying classification of M²={0, 1, 2, 3}×{0, 1, 2, 3} here is

$$\begin{matrix}{K}_{0} = \{ ( 0 , 0 ) , ( 0 , 1 ) , ( 0 , 2 ) , ( 0 , 3 ) , ( 1 , 1 ) , ( 2 , 1 ) , ( 3 , 1 ) \} ; \\ {K}_{1} = \{ ( 1 , 0 ) , ( 1 , 2 ) , ( 1 , 3 ) \} ; \\ {K}_{2} = \{ ( 2 , 0 ) , ( 2 , 2 ) , ( 2 , 3 ) \} ; \\ {K}_{3} = \{ ( 3 , 0 ) , ( 3 , 2 ) , ( 3 , 3 ) \} .\end{matrix}$$

It holds that |K₀|=7 and |K₁|=|K₂|=|K₃|=3 apply. The compression function ψ is therefore not balanced.

The number n of possible output symbols of the noise source 104 is typically a power of two. That is, n=2^{m} for an integer m≥0. Powers of two are dominant in computer architectures. In the rare cases of noise sources with a symbol set M that does not consist of 2^{m} elements, it is always possible to achieve |M|=2^{m} by introducing dummy symbols (to which zero probability of occurrence is assigned).

In the following, it is therefore assumed that n=|M|=2^{m}. Then each element σ of the symbol set M can be represented as an m-bit word or equivalently as a binary row vector of length m.

The value table of the compression function ψ: M^{r}→M is a list of all n^{r} possible input tuples (σ₁, . . . , σᵣ) with the assigned output random numbers σ. By replacing all symbols in the list with m-bit words, a binary version of the table is obtained. This (binary version of the) table contains all binary row vectors of length mr on the left side (the input side). On the right side of the table (the output side), the assigned function values of the compression function ψ are represented as binary row vectors of length m.

For each row of the (binary version of the) table, the following applies: The m-bit long (output) row vector on the right side is a function of mr binary coordinates of the input vector on the left side of the row. Since the output (row) vector has m coordinates on the right side, the following applies: Each of these coordinates is a Boolean function ψⱼ of the mentioned mr binary coordinates of the input vector. That is to say,

$$ψ = ( {ψ}_{1} , ... , {ψ}_{m} )$$

with m Boolean functions in mr binary variables in each case. This representation provides the hardware implementation of the compression function ψ.

Alternatively, the value table of ψ can be stored in the respective data processing device (e.g. in NVM 103). The post-processed, entropy-compressed value ψ(a, b) can then be determined (for an implementation of the compression function ψ in software) by table look-up.

### Example 1d (Continuation of Example 1c)

Table 1 from example 1c is considered. To create the binary version of this table, the symbol variables a are replaced by the binary variables w, x and the symbol variables b are replaced by the binary variables y, z. Table 2 is a repetition of table 1, wherein in addition to the symbol variables a, b the binary variables w, x, y, z are also listed therein.

TABLE 2
Boolean components of the compression function ψ = (ψ₁, ψ₂)

| a | b | wxyz | ψ(a, b) | ψ₁(w, x, y, z) | ψ₂(w, x, y, z) |
|---|---|---|---|---|---|
| 0 | 0 | 0000 | 0 | 0 | 0 |
| 0 | 1 | 0001 | 0 | 0 | 0 |
| 0 | 2 | 0010 | 0 | 0 | 0 |
| 0 | 3 | 0011 | 0 | 0 | 0 |
| 1 | 0 | 0100 | 1 | 0 | 1 |
| 1 | 1 | 0101 | 0 | 0 | 0 |
| 1 | 2 | 0110 | 1 | 0 | 1 |
| 1 | 3 | 0111 | 1 | 0 | 1 |
| 2 | 0 | 1000 | 2 | 1 | 0 |
| 2 | 1 | 1001 | 0 | 0 | 0 |
| 2 | 2 | 1010 | 2 | 1 | 0 |
| 2 | 3 | 1011 | 2 | 1 | 0 |
| 3 | 0 | 1100 | 3 | 1 | 1 |
| 3 | 1 | 1101 | 0 | 0 | 0 |
| 3 | 2 | 1110 | 3 | 1 | 1 |
| 3 | 3 | 1111 | 3 | 1 | 1 |

The last two columns of table 2 define the two Boolean functions ψ₁(w, x, y, z) and ψ₂(w, x, y, z), so that

$$ψ ( a , b ) = ( {ψ}_{1} ( w , x , y , z ) , {ψ}_{2} ( w , x , y , z ) ) .$$

The two Boolean functions ψ₁(w, x, y, z) and ψ₂(w, x, y, z) are given as binary column vectors of length 16. The algebraic normal forms of the Boolean functions are determined from the column vectors as follows:
1. Each 1 in the column vector (the corresponding Boolean function) yields a product term of four factors (for the Boolean function). The zeros in the column vector are ignored.
2. Each factor in the product term is either one of the variables w, x, y, z or the binary complement of such a variable. (The binary complement of the variable u is written as ū and means ū=u+1.)
3. The variable is binary complemented precisely when it represents a zero in the input vector. For example, the input vector 0110 returns the product term w̅xyz̅.
4. The sum of the product terms (for the respective Boolean function) is simplified.

Using this method, the Boolean functions ψ₁ and ψ₂ are obtained from the last two columns of table 2 as polynomials in four variables:

$$\begin{matrix}{ψ}_{1} ( w , x , y , z ) = w \overline{x} \overline{y} \overline{z} + w \overline{x} y \overline{z} + w \overline{x} yz + wx \overline{y} \overline{z} + wxy \overline{z} + wxyz \\ = w \overline{x} \overline{z} ( \overline{y} + y ) + wyz ( \overline{x} + x ) + wx \overline{z} ( \overline{y} + y ) \\ = w \overline{x} \overline{z} + wyz + wx \overline{z} \\ = w \overline{z} ( \overline{x} + x ) + wyz \\ = w \overline{z} + wyz \\ = w ( \overline{z} + yz )\end{matrix} .$$

$$\begin{matrix}{ψ}_{2} ( w , x , y , z ) = \overline{w} x \overline{y} \overline{z} + \overline{w} xy \overline{z} + \overline{w} xyz + wx \overline{y} \overline{z} + wxy \overline{z} + wxyz \\ = \overline{w} x \overline{z} ( \overline{y} + y ) + xyz ( \overline{w} + w ) + wx \overline{z} ( \overline{y} + y ) \\ = \overline{w} x \overline{z} + xyz + wx \overline{z} \\ = x \overline{z} ( \overline{w} + w ) + xyz \\ = x \overline{z} + xyz \\ = x ( \overline{z} + yz )\end{matrix} .$$

It should be noted that the above Boolean functions ψ₁ and ψ₂ are non-linear, as the variables w, x, y, z are not only additively linked, but are also multiplied.

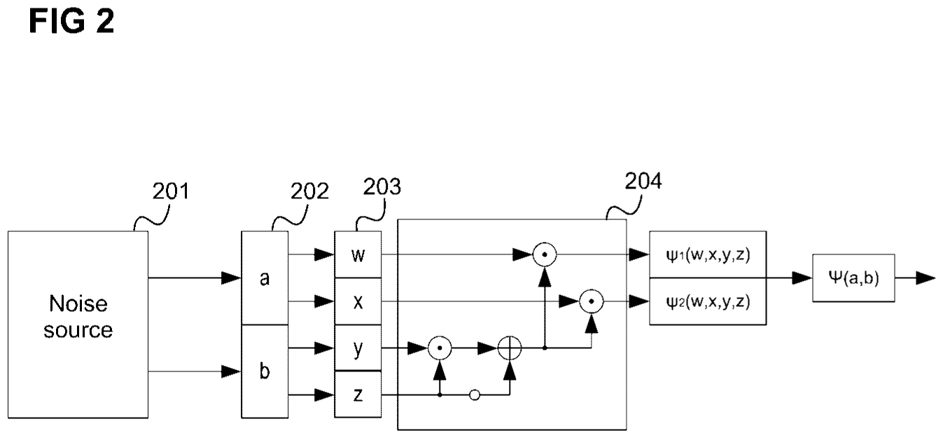

FIG. 2 shows a hardware implementation of the post-processing defined by the above-derived Boolean functions ψ₁(w, x, y, z) and ψ₂(w, x, y, z).

A noise source 201 (e.g. corresponding to the noise source 100) supplies the two output symbols a and b to a symbol buffer 202. The output symbols a and b correspond for example to the noise data 106 of FIG. 1. These are converted to their binary representation wxyz, which is stored in a digital buffer 203. A hardware entropy extractor 204 realizes the above Boolean functions ψ₁ and ψ₂. The two bits ψ₁(w, x, y, z) and ψ₂(w, x, y, z) generated in this manner together form the output random number of the random number generator. For example, they correspond to the random numbers 107 of FIG. 1.

An important property of the compression function ψ: M^{r}→M defined in part 1 is that the entropy of the output symbols generated by the post-processing can be calculated for it exactly (r≥2 is the compression rate, M is the set of the output symbols).

The sequence X₁, X₂, X₃, . . . of the symbols output by the noise source, in accordance with the requirement, forms a Markov chain with a known transition probability matrix P=(Pᵢⱼ). The sequence Y₁, Y₂, Y₃, . . . of post-processed random symbols given by

$${Y}_{1} = ψ ( {X}_{1} , ... , {X}_{r} ) , {Y}_{2} = ψ ( {X}_{r + 1} , ... , {X}_{2 r} ) , {Y}_{3} = ψ ( {X}_{2 r + 1} , ... , {X}_{3 r} ) , ...$$

for its part forms a Markov chain. The transition probabilities

$${Q}_{ij} = Pr ( {Y}_{t + 1} = j \vert {Y}_{t} = i )$$

of the Markov chain Y₁, Y₂, Y₃, . . . can be calculated from the transition probabilities Pᵢⱼ and the known (design-induced) probabilities Pr(ψ(σ₁, . . . , σᵣ)=i). It holds that

$${Q}_{ij} = \frac{1}{Pr ( ψ ( {σ}_{1} , ... , {σ}_{r} ) = i )} {\sum }_{( ( {σ}_{1} , ... , {σ}_{r} ) , ( {τ}_{1} , ... , {τ}_{r} ) ) ∈ {K}_{i} \times {K}_{j}} {μ}_{{σ}_{1}} {P}_{{σ}_{1} {σ}_{2}} {P}_{{σ}_{2} {σ}_{3}} … … {P}_{{σ}_{r - 1} {σ}_{r}} {P}_{{σ}_{r} {τ}_{1}} {P}_{{τ}_{1} {τ}_{2}} … {P}_{{τ}_{r - 1} {τ}_{r}} .$$

The entropy rate of the compressed symbol sequence Y₁, Y₂, Y₃, . . . can then be calculated from the transition probability matrix Q=(Qᵢⱼ).

### Example 1e (Continuation of the Above Examples)

Consider table 1 from example 1c. The transition probability Qᵢⱼ of the compressed symbol sequence ψ(a, b) is given by

$${Q}_{ij} = \frac{1}{Pr ( ψ ( a , b ) = i )} {\sum }_{( ( a , b ) , ( c , d ) ) ∈ {K}_{i} \times {K}_{j}} {μ}_{a} {P}_{ab} {P}_{bc} {P}_{cd} \qquad ( 3 )$$

for 0≤i, j≤3. In example 1c, it was shown that

$$Pr ( ψ ( a , b ) = i ) = \frac{1}{4} for i = 0 , 1 , 2 , 3.$$

In example 1b, the stationary probability distribution

$$μ = ( {μ}_{0} , {μ}_{1} , {μ}_{2} , {μ}_{3} ) = ( \frac{1}{12} , \frac{1}{4} , \frac{1}{3} , \frac{1}{3} )$$

of the Markov chain of the noise symbols was determined.

At the end of example 1c, the classes K₀, K₁, K₂, K₃ were described.

The transition probabilities Pᵢⱼ are taken from the matrix P in example 1a.

Applying the above formula (3) to these data yields the transition probability matrix

$$Q = ( \begin{matrix}{Q}_{00} & {Q}_{01} & {Q}_{02} & {Q}_{03} \\ {Q}_{10} & {Q}_{11} & {Q}_{12} & {Q}_{13} \\ {Q}_{20} & {Q}_{21} & {Q}_{22} & {Q}_{23} \\ {Q}_{30} & {Q}_{31} & {Q}_{32} & {Q}_{33}\end{matrix} ) = ( \begin{matrix}\frac{1}{3} & 0 & \frac{1}{3} & \frac{1}{3} \\ \frac{2}{9} & \frac{1}{3} & \frac{2}{9} & \frac{2}{9} \\ \frac{2}{9} & \frac{1}{3} & \frac{2}{9} & \frac{2}{9} \\ \frac{2}{9} & \frac{1}{3} & \frac{2}{9} & \frac{2}{9}\end{matrix} ) .$$

The associated stationary distribution

$$v = ( {v}_{0} , {v}_{1} , {v}_{2} , {v}_{3} ) = ( \frac{1}{4} , \frac{1}{4} , \frac{1}{4} , \frac{1}{4} ) .$$

The entropy rate of E of the new Markov chain (at the output of post-processing) results from the formula

$$E = - {\sum }_{i = 0}^{3} {v}_{i} {\sum }_{j = 0}^{3} {Q}_{ij} {log}_{2} {Q}_{ij} = 1.877 .$$

The entropy value 1.585 of the output sequence X₁, X₂, X₃, . . . for the compressed sequence Y₁, Y₂, Y₃, . . . has therefore increased to the value 1.877, from 79.2% to 93.9%. (The entropy value of 2 would correspond to 100% entropy.)

For example, the noise source 104, 201 is implemented as follows: A measured variable v(t), which is derived from the frequency ratio of two ring oscillators, assumes a value in the unit interval with each iteration. The evolution of the measured variable over time follows the law

$$v ( t + 1 ) = 3 v ( t ) + \frac{1}{4} mod 1.$$

The graph of the function

$$y = 3 x + \frac{1}{4}$$

mod 1 induces a division of the unit interval into four subintervals of lengths 1/12, ¼, ⅓ and ⅓. Depending on the subinterval in which the measured variable is present at time point t, the symbol 0, 1, 2 or 3 is output at time point t. From the graph of the function

$$y = 3 x + \frac{1}{4}$$

mod 1 and from the chaos-theory-implied uniform distribution property of the measured variable v(t) in the unit interval, the transition probabilities for the output symbols can be calculated. These are precisely the transition probabilities which are specified in the matrix P in (1).

The noise source 104, 201 provides true random numbers, but in general they are not yet ideal true random numbers. Post-processing turns the (low entropy) random numbers of the noise source into (increased entropy) random numbers which are then closer to ideal random numbers.

In summary, according to various aspects, a data processing device is provided, having a defining apparatus, set up for defining a number of multi-bit output symbols of a random symbol source which should be used for generating a single random number, a determination apparatus, set up for using predetermined transition probabilities between two or more output symbols of the random symbol source to determine, for every possible sequence of the specified number of multi-bit output symbols of the random symbol source, a probability that the random symbol source outputs that sequence, a grouping apparatus, set up for grouping the possible sequences of output symbols of the random symbol source into groups according to the criterion that the overall probabilities of the groups are either exactly or approximately equal, wherein for each group the overall probability is determined as the sum of the determined probabilities of the random symbol source outputting the sequences belonging to the group, and an assignment apparatus, set up for assigning a random number to each group as a random number which is to be output by the random number generator for the sequences of the random symbols which belong to the group.

The data processing device can for example correspond to the data processing device of FIG. 1, i.e. the various apparatuses (defining apparatus, determination apparatus, grouping apparatus and assignment apparatus and possibly further apparatuses) can be realized e.g. by the CPU 101 and/or the coprocessor 105. However, the data processing device itself does not need to contain the noise source, i.e. the random number generator can be implemented on another data processing device (which is at least partially configured by the data processing device).

The various apparatuses (defining apparatus, determination apparatus, grouping apparatus and assignment apparatus and possibly further apparatuses) can be carried out by one or more computers with one or more data processing units. The term “data processing unit” can be understood as any type of entity that enables the processing of data or signals. For example, the data or signals may be handled according to at least one (i.e. one or more than one) specific function performed by the data processing unit. A data processing unit may comprise an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA) or any combination thereof or be formed from same. Any other way of implementing the respective functions described in more detail herein may also be understood as a data processing unit or logic circuit arrangement. One or more of the method steps described in detail herein may be performed (e.g. implemented) by a data processing unit through one or more specific functions performed by the data processing unit.

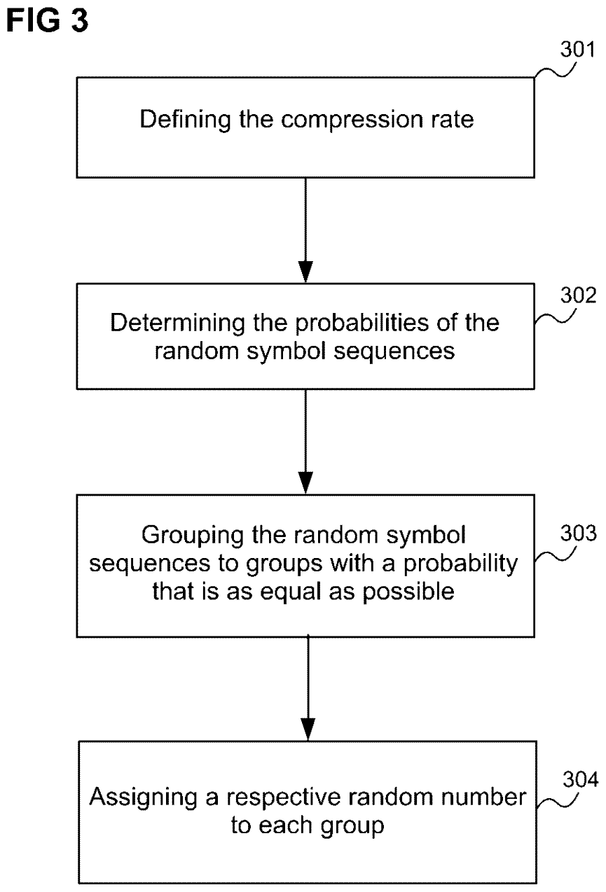

In accordance with various aspects, a method as illustrated in FIG. 3 is provided.

FIG. 3 shows a flowchart 300 that illustrates a method for configuring a random number generator.

In 301, a number (designated r above) of multi-bit output symbols (designated σ₁, σ₂, . . . , σᵣ above) of a random symbol source (also referred to as a noise source in the above examples) are defined, which should be used to generate a single random number (this corresponds to defining the compression rate in post-processing).

In 302, the probability with which the random symbol source outputs the sequence (i.e. of P(σ₁, σ₂, . . . , σᵣ), e.g. by means of P(σ₁, σ₂, . . . , σᵣ)=μ_{σ}_{₁}P_{σ}_{₁}_{σ}_{₂}P_{σ}_{₂}_{σ}_{₃} . . . P_{σ}_{_{r- 1}}_{σ}_{ᵣ}) is determined for every possible sequence of the specified number of multi-bit output symbols of the random symbol source. This takes place using predetermined transition probabilities between two or more output symbols of the random symbol source (i.e. e.g. of P_{σ}_{₁}_{σ}_{₂}P_{σ}_{₂}_{σ}_{₃} . . . P_{σ}_{ᵣ₋₁}_{σ}_{ᵣ}).

In 303, the possible sequences of output symbols of the random symbol source are grouped according to the criterion that the overall probabilities of the groups are as equal as possible (i.e. come as close as possible to equality: Even if grouping takes place according to the criterion of equality, it is not guaranteed that it is possible that the overall probabilities are exactly equal; but if possible, grouping can be performed such that the overall probabilities of the groups are equal, as is the case in the example above), wherein for each group, the overall probability is determined as the sum of the determined probabilities that the random symbol source outputs the sequences belonging to the group (i.e. for example as Σ_{(σ}_{₁}_{, . . . , σ}_{ᵣ}_{)∈K}_{ᵢ}μ_{σ}_{₁}P_{σ}_{₁}_{σ}_{₂}P_{σ}_{₂}_{σ}_{₃} . . . P_{σ}_{ᵣ₋₁}_{σ}_{ᵣ}).

In 304, a random number is assigned to each group as a random number, which is output by the random number generator for the sequences of the random symbols belonging to the group (i.e. is to be output e.g. from the same alphabet as the multi-bit output symbols of the random symbol source or else from another e.g. smaller alphabet (for stronger compression); the number of groups specifies how many possible different random numbers can be generated). The random number generator is configured such that, for each sequence of random symbols, it outputs the random number which is assigned to the group to which the sequence of random symbols belongs.

According to various aspects, a random number generator is configured such that it implements entropy compression in which the random symbols that are combined are not combined in a (numerically) balanced manner, but according to the overall probabilities of the groups which they are combined to form.

As described above, the probability that the random symbol source outputs a respective sequence can be determined according to a Markov model for the random symbol source. In this case, if multi-step dependencies exist, output symbols can also be combined, so that the Markov property applies in turn for the larger symbols that result in this manner.

In addition, the random symbol source for its part can also be configured like the random number generator (using a “further” (e.g. “original” or “underlying” random symbol source, e.g. noise source). In other words, the method can be applied iteratively, since the random numbers that are generated can in turn be compressed in the same way to further increase the entropy, i.e. a configured random number generator is the random symbol source for a further random number generator (of a next iteration) (based on it). As in the above example, use can be made of the fact that the output of the random number generator (i.e. the sequence of random numbers or output symbols after compression) can again be considered as a Markov chain.

Various exemplary aspects are specified below.

Exemplary aspect 1 is a data processing device having:
a defining apparatus, set up for defining a number of multi-bit output symbols of a random symbol source which should be used for generating a single random number;
a determination apparatus, set up for using predetermined transition probabilities between two or more output symbols of the random symbol source to determine, for every possible sequence of the specified number of multi-bit output symbols of the random symbol source, a probability that the random symbol source outputs that sequence;
a grouping apparatus, set up for grouping the possible sequences of output symbols of the random symbol source into groups according to the criterion that the overall probabilities of the groups are as equal as possible, wherein for each group the overall probability is determined as the sum of the determined probabilities of the random symbol source outputting the sequences belonging to the group; and
an assignment apparatus, set up for assigning a random number to each group as a random number which is to be output by the random number generator for the sequences of the random symbols which belong to the group.

Exemplary aspect 2 is a data processing device according to exemplary aspect 1, having a function forming apparatus set up for forming a compression function by forming a Boolean function for each bit position of the random number to be generated, wherein, for each sequence of the possible sequences of the specified number of multi-bit output symbols, the compression function maps the sequence onto the random number which is assigned to the group to which the sequence belongs, and an implementation apparatus is set up for implementing the compression function in the random number generator.

Exemplary aspect 3 is a data processing device according to exemplary aspect 2, wherein the implementation apparatus is set up for implementing the compression function in the form of a hardware implementation which implements the Boolean functions as logic gate arrangements.

Exemplary aspect 4 is a data processing device according to any one of exemplary aspects 1 to 3, wherein the determination apparatus is set up for determining, for every possible sequence of the specified number of multi-bit output symbols of the random symbol source, the probability that the random symbol source outputs the sequence according to a Markov model for the random symbol source.

Exemplary aspect 5 is a data processing device according to any one of exemplary aspects 1 to 4, wherein at least some of the groups contain a different number of the possible sequences of output symbols.

Exemplary aspect 6 is a data processing device according to any one of exemplary aspects 1 to 5, having a control device, set up for controlling the random number generator for generating one or more random numbers by receiving a sequence of the specified number of multi-bit output symbols of the random symbol source for each random number and outputting the random number which is assigned to the group to which the received sequence of output symbols belongs.

Exemplary aspect 7 is a data processing device according to exemplary aspect 2 or 3, having a control device, set up for controlling the random number generator for generating one or more random numbers by receiving a sequence of the specified number of multi-bit output symbols of the random symbol source for each random number and determining the random number which is assigned to the group to which the received sequence of output symbols belongs by applying the compression function to the sequence of output symbols that is received and outputting the random number that is determined.

Exemplary aspect 8 is a data processing device according to exemplary aspect 6 or 7, having a configuration apparatus, set up for configuring the random symbol source as a random number generator according to any one of exemplary aspects 1 to 5.

Exemplary aspect 9 is a method for configuring a random number generator, as described above with reference to FIG. 3.

Exemplary aspect 10 is a method according to exemplary aspect 9, comprising forming a compression function by forming a Boolean function for each bit position of the random number to be generated, wherein, for each sequence of the possible sequences of the specified number of multi-bit output symbols, the compression function maps the sequence onto the random number which is assigned to the group to which the sequence belongs, and implementing the compression function in the random number generator.

Exemplary aspect 11 is a method according to exemplary aspect 10, comprising implementing the compression function in the form of a hardware implementation which implements the Boolean functions as logic gate arrangements.

Exemplary aspect 12 is a method according to any one of exemplary aspects 9 to 11, comprising determining, for every possible sequence of the specified number of multi-bit output symbols of the random symbol source, the probability that the random symbol source outputs the sequence according to a Markov model for the random symbol source.

Exemplary aspect 13 is a method according to any one of exemplary aspects 9 to 12, wherein at least some of the groups contain a different number of the possible sequences of output symbols.

Exemplary aspect 14 is a method for generating random numbers, comprising configuring a random number generator according to any one of exemplary aspects 9 to 13 and generating one or more random numbers by receiving a sequence of the specified number of multi-bit output symbols of the random symbol source for each random number and outputting the random number which is assigned to the group to which the received sequence of output symbols belongs.

Exemplary aspect 15 is a method for generating random numbers, comprising configuring a random number generator according to exemplary aspect 10 or 11 and generating one or more random numbers by receiving a sequence of the specified number of multi-bit output symbols of the random symbol source for each random number and determining the random number which is assigned to the group to which the received sequence of output symbols belongs by applying the compression function to the sequence of output symbols that is received and outputting the random number that is determined.

Exemplary aspect 16 is a method according to exemplary aspect 14 or 15, comprising configuring the random symbol source as a random number generator according to any one of exemplary aspects 9 to 13.

Exemplary aspect 17 is a random number generator configured according to any one of exemplary aspects 9 to 13.

According to further exemplary aspects, a computer program element and/or a computer-readable memory medium can be provided, which have instructions which, if they are executed by a processor, cause the processor to carry out a method according to the above exemplary aspects.

Although the aspects of the disclosure have been shown and described primarily with reference to specific aspects, it should be understood by those familiar with the technical field that numerous modifications may be made thereto with regard to configuration and details, without departing from the essence and scope of the disclosure as defined by the claims hereinafter. The scope of the disclosure is therefore determined by the appended claims, and the intention is for all modifications that come under the literal meaning or the scope of equivalence of the claims to be encompassed.

### LIST OF REFERENCE SIGNS

100 Data processing device
101 CPU
102 RAM
103 NVM
104 Noise source
105 Coprocessor
201 Noise source
202 Symbol buffer
203 Digital buffer
204 Hardware entropy extractor
300 Flowchart
301-304 Sequence steps

1-17. (canceled)

18. A data processing device, comprising:
a defining apparatus configured to define a number of multi-bit output symbols of a random symbol source used to generate a single random number;
a determination apparatus configured to use predetermined transition probabilities between two or more output symbols of the random symbol source to determine, for every possible sequence of the number of multi-bit output symbols of the random symbol source, a probability that the random symbol source outputs that sequence;
a grouping apparatus configured to group the possible sequences of output symbols of the random symbol source into groups according to a criterion that overall probabilities of the groups are as equal as possible, wherein for each group the overall probability is determined as a sum of the determined probabilities of the random symbol source outputting the sequences belonging to the group; and
an assignment apparatus configured to assign a random number to each group as a random number that is to be output by the random number generator for the sequences of the random symbols that belong to the group.

19. The data processing device as claimed in claim 18, further comprising:
a function forming apparatus configured to form a compression function by forming a Boolean function for each bit position of the random number to be generated, wherein, for each sequence of the possible sequences of the number of multi-bit output symbols, the compression function maps the sequence onto the random number which is assigned to the group to which the sequence belongs; and
an implementation apparatus configured to implement the compression function in the random number generator.

20. The data processing device as claimed in claim 19, wherein the implementation apparatus is set up for implementing the compression function in the form of a hardware implementation which implements the Boolean functions as logic gate arrangements.

21. The data processing device as claimed in claim 18, wherein the determination apparatus is further configured to determine, for every possible sequence of the number of multi-bit output symbols of the random symbol source, the probability that the random symbol source outputs the sequence according to a Markov model for the random symbol source.

22. The data processing device as claimed in claim 18, wherein at least some of the groups contain a different number of the possible sequences of output symbols.

23. The data processing device as claimed in claim 18, further comprising:
a control device configured to control the random number generator for generating one or more random numbers by receiving a sequence of the number of multi-bit output symbols of the random symbol source for each random number and outputting the random number that is assigned to the group to which the received sequence of output symbols belongs.

24. The data processing device as claimed in claim 19, further comprising:
a control device configured to control the random number generator for generating one or more random numbers by receiving a sequence of the number of multi-bit output symbols of the random symbol source for each random number and determining the random number which is assigned to the group to which the received sequence of output symbols belongs by applying the compression function to the sequence of output symbols that is received and outputting the random number that is determined.

25. The data processing device as claimed in claim 23, further comprising a configuration apparatus configured to configure the random symbol source as the random number generator.

26. A method for configuring a random number generator, comprising:
defining a number of multi-bit output symbols of a random symbol source to be used for generating a single random number;
using predetermined transition probabilities between two or more output symbols of the random symbol source to determine, for every possible sequence of the number of multi-bit output symbols of the random symbol source, a probability that the random symbol source outputs that sequence;
grouping the possible sequences of output symbols of the random symbol source into groups according to a criterion that overall probabilities of the groups are as equal as possible, wherein for each group the overall probability is determined as a sum of the determined probabilities of the random symbol source outputting the sequences belonging to the group; and
assigning a random number to each group as a random number that is to be output by the random number generator for the sequences of the random symbols that belong to the group.

27. The method as claimed in claim 26, further comprising:
forming a compression function by forming a Boolean function for each bit position of the random number to be generated, wherein, for each sequence of the possible sequences of the number of multi-bit output symbols, the compression function maps the sequence onto the random number which is assigned to the group to which the sequence belongs; and
implementing the compression function in the random number generator.

28. The method as claimed in claim 27, further comprising:
implementing the compression function in the form of a hardware implementation that implements the Boolean functions as logic gate arrangements.

29. The method as claimed in claim 26, further comprising:
determining, for every possible sequence of the number of multi-bit output symbols of the random symbol source, the probability that the random symbol source outputs the sequence according to a Markov model for the random symbol source.

30. The method as claimed in claim 26, wherein at least some of the groups contain a different number of the possible sequences of output symbols.

31. A method for generating random numbers, comprising:
configuring a random number generator as claimed in claim 26; and
generating one or more random numbers by receiving a sequence of the number of multi-bit output symbols of the random symbol source for each random number and outputting the random number which is assigned to the group to which the received sequence of output symbols belongs.

32. A method for generating random numbers, comprising:
configuring a random number generator as claimed in claim 27; and
generating one or more random numbers by receiving a sequence of the number of multi-bit output symbols of the random symbol source for each random number and determining the random number which is assigned to the group to which the received sequence of output symbols belongs by applying the compression function to the sequence of output symbols that is received and outputting the random number that is determined.

33. The method as claimed in claim 31, comprising configuring the random symbol source as the random number generator.

34. A random number generator configured according to the method as claimed in claim 26.
